(19) United States
(12) Patent Application Publication
(10) Pub. No.: US 2023/0108228 A1
(43) Pub. Date: Apr. 6, 2023

(54) VALIDATING CREDENTIAL KEYS BASED ON COMBINATIONS OF CREDENTIAL VALUE STRINGS AND INPUT ORDER STRINGS

(71) Applicant: GLOBUS MEDICAL, INC., Audubon, PA (US)

(72) Inventor: Sanjay M. Joshi, Andover, MA (US)

(21) Appl. No.: 17/492,893

(22) Filed: Oct. 4, 2021

(51) Int. Cl. H04L 9/40; G06F 21/60; G06F 21/31; G06F 21/43; G06F 3/0486; G06F 21/36

(52) U.S. Cl. CPC H04L 63/083; H04L 63/10; G06F 21/602; G06F 21/31; G06F 21/43; H04L 63/0815; G06F 3/0486; G06F 21/36; G06F 2221/0751

(57) ABSTRACT

An electronic device includes at least one processor and at least one memory storing instructions executable by the at least one processor. The at least one processor operates to obtain a credential value string indicating a sequence of credential values entered by a user through a user interface as a part of a credential key. The at least one processor operates to obtain an input order string indicating an order in which individual ones of the sequence of credential values were separately entered by the user through the user interface as another part of the credential key. The at least one processor operates to validate the credential key based on the credential value string and based on the input order string.

### CROSS-REFERENCE TO RELATED APPLICATIONS

This application is a continuation application of U.S. patent application Ser. No. 17/492,811 filed on Oct. 4, 2021, which is incorporated in its entirety herein.

### TECHNICAL FIELD

The present disclosure relates to electronic devices which validate credential keys for users, software products, and/or hardware devices based on user inputs.

### BACKGROUND

A credential key may be used to control access to resources of an electronic device and/or to resources that are accessible through the electronic device. The credential key may be associated with a user, such as by associating unique credential keys to different users, e.g., associating secret passwords with unique user identifiers. The credential keys may be associated with software or hardware, such as by associating a unique activation code or access code with software or hardware which may be a resource of the electronic device or accessible through the electronic device. Examples of credential keys can include, without limitation, a numeric personal identification number (PIN) code, cryptographically encoded software activation key, and account login identifier and password. Examples of electronic devices which can contain resources having user access controlled through a credential key include, without limitation, cellular phones, laptop computers, tablet computers, desktop computers, smart appliances which may communicate via the Internet (e.g., thermostats, televisions, refrigerators, etc.), website servers, application servers, and cloud computing servers.

A credential key may be entered by a user through an interface, such as by touch-typing on a virtual display (e.g., touch sensitive display) or physical keypad or keyboard. An algorithm verifies the entered credential key, such as by comparing the entered credential key to a predefined credential key which has been associated with the user, a software resource, a hardware resource, etc. When the entered credential key is properly validated, the user may be provided access to resources of the electronic device and/or which are accessible through the electronic device.

It is becoming increasingly more difficult to ensure that access to resources of electronic devices access remain secure as approaches for brute force trial-and-error access attempts and other hacking techniques are becoming more sophisticated and readily available for malicious purposes. Countermeasures for increasing security have included requiring use of lengthier and more complex credential keys, and requiring more frequency change of credential keys. These countermeasures are imposing increasingly undesirable burdens on the users who must remember and correctly enter the credential keys through sometimes inconvenient user interfaces, such as small touch displays of cellular phones.

There is therefore a substantial continuing need to provide improved secure access to resources of electronic devices while providing an acceptable process for user entry of credential keys.

### SUMMARY

Various embodiments disclosed herein are directed to providing an improved process for user entry of credential keys that may provide increased security for access to resources of electronic devices and/or may provide a more user-acceptable process for entry of credential keys.

Some embodiments are directed to an electronic device that includes at least one processor and at least one memory storing instructions executable by the at least one processor. The at least one processor operates to obtain a credential value string indicating a sequence of credential values entered by a user through a user interface as a part of a credential key. The at least one processor operates to obtain an input order string indicating an order in which individual ones of the sequence of credential values were separately entered by the user through the user interface as another part of the credential key. The at least one processor operates to validate the credential key based on the credential value string and based on the input order string.

Some other related embodiments are directed to a computer program product that includes a non-transitory computer readable medium storing instructions executable by at least processor of an electronic device. The instructions obtain a credential value string indicating a sequence of credential values entered by a user through a user interface as part of a credential key. The instructions obtain an input order string indicating an order in which individual ones of the sequence of credential values were separately entered by the user through the user interface as another part of the credential key. The instructions validate the credential key based on the credential value string and based on the input order string.

Using the sequence of credential values entered by a user and the order in which individual ones of the sequence of credential values were separately entered by the user through the user interface, as parts of a credential key enables creation of a stronger credential key that can be much more difficult to overcome using present hacking techniques and/or enables use of a reduced length of credential values (e.g., shorter password) and/or use of less complex credential values (e.g., simpler passwords).

Other electronic devices and computer program products according to embodiments of the inventive subject matter will be or become apparent to one with skill in the art upon review of the following drawings and detailed description. It is intended that all such additional electronic devices and computer program products be included within this description, be within the scope of the present inventive subject matter, and be protected by the accompanying claims. Moreover, it is intended that all embodiments disclosed herein can be implemented separately or combined in any way and/or combination

### BRIEF DESCRIPTION OF THE DRAWINGS

Aspects of the present disclosure are illustrated by way of example and are not limited by the accompanying drawings. In the drawings:

FIG. 1 illustrates a system in which a user can enter a credential key through a user interface of a user device for validation by the user device or by a network node to obtain access to resources of the user device and/or the network node in accordance with some embodiments of the present disclosure;

FIG. 2 is a block diagram illustrating components of an electronic device which verifies a credential key to control access to resources of the electronic device in accordance with some embodiments of the present disclosure;

FIG. 3 illustrates alternative sequences in which a user may enter credential values, with operations forming a credential value string indicating a sequence of the credential values entered by the user as one part of the credential key and other operations forming an input order string indicating an order in which individual ones of the sequence of credential values were separately entered by the user as another part of the credential key, in accordance with some embodiments of the present disclosure;

FIG. 4 illustrates a credential value string and an input order string which are generated as two parts of a credential key in accordance with some embodiments of the present disclosure based on a user entering a credential values through a keypad;

FIG. 5 illustrates a credential value string and an input order string which are generated as two parts of a credential key based on a user moving (e.g., dragging on a touch display) and/or selecting symbols arranged in a grid, in accordance with some embodiments of the present disclosure;

FIG. 6 illustrates a credential value string and an input order string which are generated as two parts of a credential key based on a user moving (e.g., dragging on a touch display) symbols arranged in a grid, in accordance with some embodiments of the present disclosure;

FIG. 7 illustrates a credential value string and an input order string which are generated as two parts of a credential key based on a user dragging symbols from a grid to spaced apart locations on a display device to assemble a sequence which forms the credential value string in accordance with some embodiments of the present disclosure;

FIG. 8 illustrates a grid of symbols which are displayed for touch selection by a user to generate a credential value string and an input order string as two parts of a credential key in accordance with some embodiments of the present disclosure;

FIG. 9 illustrates a table which shows the number of permutations provided by different lengths of credential value strings and number of ones in accordance with some embodiments of the present disclosure;

FIGS. 10A, 10B, 10C, and 10D illustrate four alternative patterns of blocks in a grid which have been selected by a user to generate a credential value string as one part of a credential key and further illustrate associated orders in which the user separately selected the blocks to generate the input order string as another part of credential key, in accordance with some embodiments of the present disclosure;

FIGS. 11A, 11B, 11C, and 11D illustrate four alternative patterns of blocks in a grid which have been selected by a user to form a stylized “S” as a credential value string for one part of a credential key and further illustrate associated orders in which the user separately selected the blocks to generate the input order string as another part of credential key, in accordance with some embodiments of the present disclosure;

FIG. 12 illustrates components of a user device which are configured to operate in accordance with some embodiments of the present disclosure;

FIG. 13 illustrates components of a network node which are configured to operate in accordance with some embodiments of the present disclosure; and

FIG. 14 illustrates a flowchart of operations by an electronic device to obtain a credential value string and an input order string as parts of a credential key and to validate the credential key in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

When validating credential keys, prior devices have only validated a sequence of credential values, such as an authentication code or password, as finally entered by the user as the entirety of the credential key. Embodiments of the present disclosure create another part of a credential key which indicates an order in which individual ones of the sequence of credential values were separately entered by the user through a user interface. The order of entry carries significant information which is also used for the validation. Using the sequence of credential values entered by a user and the order in which individual ones of the sequence of credential values were separately entered by the user through the user interface, as parts of a credential key enables creation of a stronger credential key that can be much more difficult to overcome using present hacking techniques and/or enables use of a reduced length of credential values (e.g., shorter password) and/or use of less complex credential values (e.g., simpler passwords).

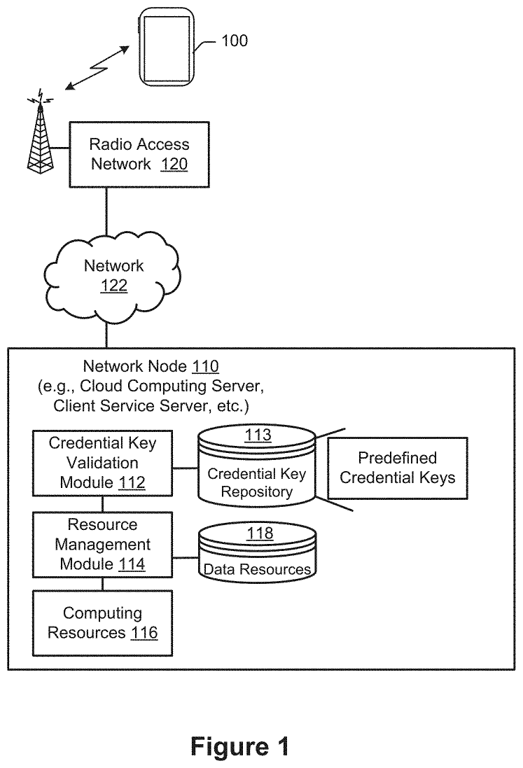

Some embodiments of the present disclosure are now described in the context of FIG. 1 which illustrates a system in which a user can enter a credential key through a user interface of a user device 100 for validation by the user device 100 or by a network node 110 to obtain access to resources of the user device 100, the network node 110, and/or another electronic device in accordance with some embodiments of the present disclosure. The credential key can include two parts: 1) a credential value string which indicates a sequence of credential values entered by a user through a user interface; and 2) an input order string which indicates an order in which individual ones of the sequence of credential values were separately entered by the user through the user interface as the credential key.

Referring to FIG. 1, the user device 100 communicates through a radio access network 120 and a network 122 (e.g., private network or public network such as Internet) with a network node 110. The user device 100 may include, without limitation, a tablet computer, desktop computer, smartphone, smart appliance such as an Internet thermostat, Internet camera, Internet smart speaker, etc. The network node may include, without limitation, a website server, a client account server, an application data server, a cloud computing server, etc. In an example operation, the network node 110 can operate to validate credential keys entered by the user through the user device 100. The network node 110 may include a credential key validation module 112 which can validate a credential key received for the user device 100, based on predefined credential keys in a repository 113.

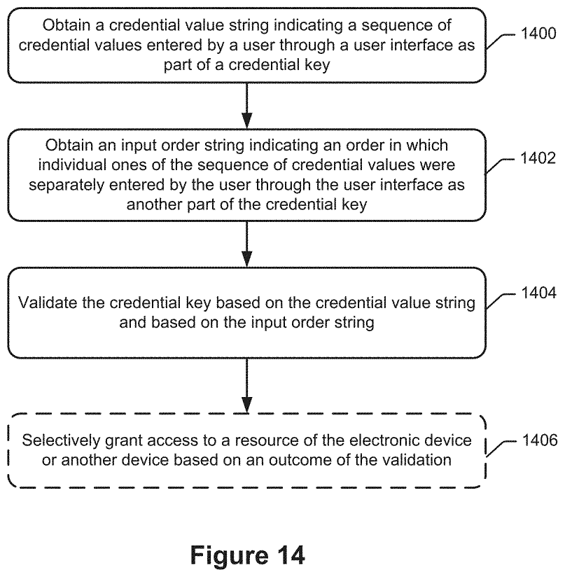

FIG. 14 illustrates a flowchart of operations which may be performed by the network node 110 to obtain a credential value string and an input order string as parts of a credential key and to validate the credential key in accordance with some embodiments of the present disclosure.

Referring to FIG. 14, the network node 110 (e.g., via the credential key validation module 112) obtains 1400 a credential value string which indicates a sequence of credential values entered by a user through a user interface as part of a credential key The network node 110 (e.g., via the credential key validation module 112) also obtains 1402 an input order string which indicates an order in which individual ones of the sequence of credential values were separately entered by the user through the user interface as another part of the credential key. In the example of FIG. 1, the network node obtains 1400 and 1402 the credential value string and the input order string from the user device 100.

The network node 110 (e.g., via the credential key validation module 112) validates 1404 the credential key based on the credential value string and based on the input order string.

In one embodiment, the validation 1404 includes comparing the sequence of credential values indicated by the credential value string to credential values of a predefined credential value string for the user and based on comparing the order indicated by the input order string to a predefined input order of a predefined credential order string for the user.

In another alternative embodiment, the validation 1404 includes comparing a credential key value, which is generated based on an algorithmic combination of the credential value string and the input order string, to a predefined credential key value. For example, the validation 1404 may include combining the credential value string and the input order string to generate a combined value that is hashed to form the credential key value. The credential key value can then be compared to the predefined credential key value which can correspond to a hashed value that was formed from an algorithmic combination of a predefined credential value string (e.g., defined by the user, a software developer, and/or another individual or process) and a predefined input order string (e.g., also defined by the user, the software developer, and/or the other individual or process). Before the respective hashing operations for the credential key value and the predefined credential key value, the inputs to the respective hashing operations may each be combined with a random string in a defined manner to further complicate any hacking attempts. Validation is considered successful when the credential key value matches the predefined credential key value. Comparing hashed-based values is more secure than comparing plain-text strings which may be discoverable through hacking attempts.

In accordance with the alternative embodiments, the repository 113 can store either: 1) pairs of a predefined credential value string and a predefined credential order string which are associated with a user, such as by associating different pairs of a predefined credential value string and a predefined credential order string with different users; or 2) a predefined credential key value which is associated with the user, such as by associating different predefined credential key values with different users. Alternatively or additionally, the repository 113 can associate the pairs of a predefined credential value string and a predefined credential order string or the predefined credential key values with identified software or hardware. For example, the repository 113 may associate different pairs of a predefined credential value string and a predefined credential order string or different predefined credential key values with different software identifiers or hardware identifiers, which may include associating a unique activation code or access code with software or hardware which may be a resource of the electronic device (e.g., 100 or 110) or accessible through the electronic device.

In one embodiment, the credential key validation module 112 operates to access the repository 113 using an identifier of the user to obtain the predefined credential value string and the predefined credential order string or to obtain the predefined credential key value for use in validation. In another embodiment, the credential key validation module 112 operates to access the repository 113 using an identifier of a software resource and/or a hardware resource to obtain the predefined credential value string and the predefined credential order string or to obtain the predefined credential key value for use in validation.

The network node 110 (e.g., via a resource management module 115) may also grant 1406 the user access to resources of the network node 110 based on determining that the sequence of credential values indicated by the credential value string matches the credential values of the predefined credential value string and based on determining that the order indicated by the input order string matches the predefined input order of the predefined credential order string. Alternatively the network node 110 may also grant 1406 the user access to resources of the network node 110 based on determining that the credential key value matches the predefined credential key value. For example, the network node 110 may grant the user access to data resources 118, which may include one or more of user account data, streaming media (e.g., movies, television shows, etc.), application data, website data, software program code, etc., and/or may grant the user access to computing resources 116, which may include one or more of processor resources, volatile and/or non-volatile memory resources, communication resources of a wireless radio access resources of a radio access network, communication resources of a wired network, etc.

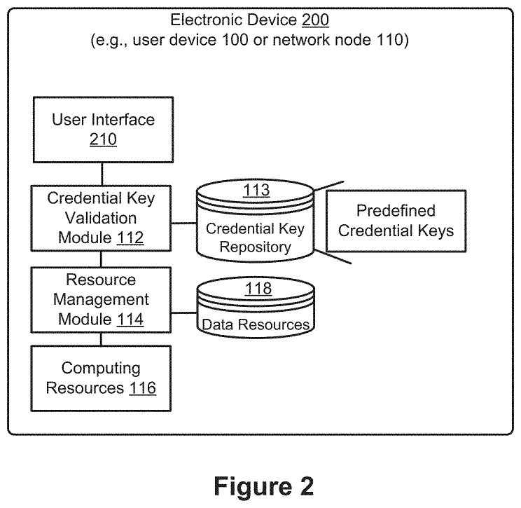

In some other embodiments, an electronic device can operate stand-alone to validate a credential key from a user. The term “electronic device” is used more generally to cover any device which is operative to obtain and validate a credential key (i.e., pair of credential value string and input order string), and can include but is not limited to the user device 100 or the network node 110 of FIG. 1. FIG. 2 is a block diagram illustrating components of an electronic device 200 which verifies a credential key to control access to resources of the electronic device 200 in accordance with some embodiments of the present disclosure.

The electronic device 200 (e.g., via the credential key validation module 112) obtains through a user interface 210 a credential value string which indicates a sequence of credential values entered by a user through a user interface as part of a credential key. The user interface 210 may be a physical interface, e.g., keyboard or keypad, or may be virtual such as through a touch display representation. The electronic device 200 (e.g., via the credential key validation module 112) also obtains an input order string which indicates an order in which individual ones of the sequence of credential values were separately entered by the user through the user interface as another part of the credential key. The electronic device 200 (e.g., via the credential key validation module 112) validates the credential key based on: 1) comparing the sequence of credential values indicated by the credential value string to credential values of a predefined credential value string for the user and based on comparing the order indicated by the input order string to a predefined input order of a predefined credential order string for the user; or 2) comparing the credential key value to the predefined credential key value.

The electronic device 200 (e.g., via a resource management module 115) may also grant 1406 the user access to resources of the network node 110 based on: 1) determining that the sequence of credential values indicated by the credential value string matches the credential values of the predefined credential value string and based on determining that the order indicated by the input order string matches the predefined input order of the predefined credential order string; or 2) determining that the credential key value matches the predefined credential key value. For example, the electronic device 200 may grant the user access to data resources 118 and/or may grant the user access to computing resources 116.

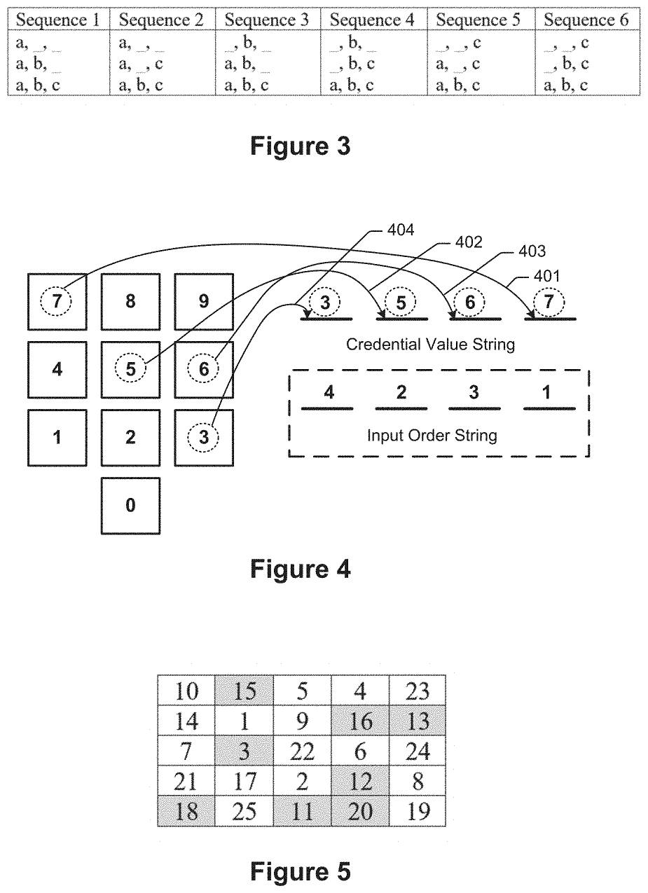

Example operations through which an electronic device can obtain a credential value string and an input order string as parts of a credential key from a user for validation are now described in the context of FIGS. 3 through 8 in accordance with some embodiments of the present disclosure.

In a conventional validation process for an electronic device, when using an English keyboard, values (symbols) of a credential key are entered from left to right as individual symbols with a separate key being used to signal that entry is complete. Some user interfaces allow a user to move to the right or left using arrow keys, mouse selections, and/or by touching different areas of a touch sensitivity display. The conventional electronic device processes the information after all symbol entries are complete, usually signaled by a different key, such as the “Enter” keyboard key. In this situation, the sequence in which the symbols was entered does not matter, since only the final sequence of credential values is used as the credential key to be validated.

In accordance with some embodiments of the present disclosure, an electronic device operates to process the credential values as the user enters each one. A credential key is formed that has two parts: 1) a credential value string indicating a sequence of credential values entered by a user through a user interface as a part of a credential key; and 2) an input order string indicating an order in which individual ones of the sequence of credential values were separately entered by the user through the user interface as another part of the credential key.

FIG. 3 illustrates alternative sequences in which a user may enter credential values, with operations forming a credential value string indicating a sequence of the credential values entered by the user as one part of the credential key and other operations forming an input order string indicating an order in which individual ones of the sequence of credential values were separately entered by the user as another part of the credential key, in accordance with some embodiments of the present disclosure.

Referring to FIG. 3, a credential value string is formed as a sequence of three credential values. Each credential value can take r possible values which creates r³ possible combinations of credential value strings. For example, a user can enter a three-length credential value string “a, b, c” in six different orders as shown. The first row shows the status at the end of entering one credential value, the second two row at the end of entering the second credential value, and the third row at the end of entering the third credential value. Though the credential value string created by each sequence is the same, the various sequences of entry encode 6 input order strings.

More generally, when entering an n-symbol, each with m bits, credential value string, the place of the first credential value can be chosen in n possible ways. The position of the second credential value can be chosen in n−1 possible ways. Extending this further, the total number of possibilities encoded in the sequence of placement of the credential value is n·(n−1)·(n−2) . . . ·1=n!. If each credential value can take r=2^{m} possible values, the number of possibilities become n!·rⁿ. Thus, the number of bits the credential key can encode is log₂(n!·rⁿ)=log₂ n!+n log₂ r=log₂ n!+n m.

When a credential value string has 4 credential values, where each credential value is represented by two values or one bit (i.e., n=4, m=1). The user can select a position with a click of a mouse or display touch and entering a 0 or 1 at a selected sequence position in the credential value string. The user entry may alternatively by performed by dragging a “1” or “0” credential value to the desired sequence position in the credential value string. The amount of information encoded is then log₂ 4!+1·4=4.6+4=16.6, or 16 bits when rounded below. If the user enters or drags a nibble for each credential value, the amount of information carried will be log₂ 4!+4·4=4.6+16=20.6, or 20 bits when rounded below.

The increased number of permutations created for a defined length credential value string when combined with the input order string, increases rapidly as shown in the table below.

FIG. 4 illustrates a credential value string and an input order string which are generated as two parts of a credential key in accordance with some embodiments of the present disclosure based on a user entering a credential values through a virtual keypad displayed on a touch sensitive display.

Referring to FIG. 4, when the user inputs are made through a touch sensitive display that provides drag-and-drop operations, as a first input the user touches the number “7” on the displayed keypad and drags 401 the number “7” to the fourth location (furthest right) in the credential value string. As a second input the user similarly drags 402 the number “5” to the second location in the credential value string. As a third input the user similarly drags 403 the number “6” to the third location in the credential value string. As a fourth input the user similarly drags 404 the number “3” to the first location in the credential value string. The operations respond to the user inputs by generating a credential value string of “3567” indicating the sequence of credential values entered by a user through the user interface as a part of a credential key, and further generates an input order string as “4231” indicating an order in which individual ones of the sequence of credential values were separately entered by the user through the user interface as another part of the credential key.

The electronic device then validates the credential key based on the sequence of credential values “3567” indicated by the credential value string and based on the order “4231” indicated by the input order string

FIG. 5 illustrates a credential value string and an input order string which are generated as two parts of a credential key based on a user moving (e.g., dragging on a touch display) and/or selecting symbols arranged in a grid, in accordance with some embodiments of the present disclosure. From the table above, the same number of bits can be encoded by a sequence of a 25-value (25-symbol) binary message. The 25-value (25-symbol) message can be arranged in a 5×5 grid such as shown in FIG. 5 for intuitive viewing and manipulation by a user. A user can enter a credential key by touch-selecting symbols to turn white or dark (i.e., set value values) and/or dragging white and dark symbols within the 5×5 grid. The final pattern of symbols (e.g., the illustrated locations of the white and dark symbols) within the 5×5 grid becomes the credential value string part of the credential key and the order (e.g., the illustrated numbers within the symbols) in which individual ones of the symbols were selected and/or moved by the user becomes the input order string part of the credential key.

Instead of dragging of a white or dark symbol, a user could also touch-select or mouse-click a symbol once to define a white symbol and touch or click it again to define a dark symbol.

Corresponding operations that can be performed by the electronic device can include to display a plurality of indicia on a display device, where each of the indicia indicates a location where the user can enter one of the credential values. The operations generate the credential value string to indicate credential values entered by the user at the locations indicated by the plurality of indicia, and generate the input order string to indicate an order in which individual ones of the credential values were entered at the locations indicated by the plurality of indicia were selected by the user.

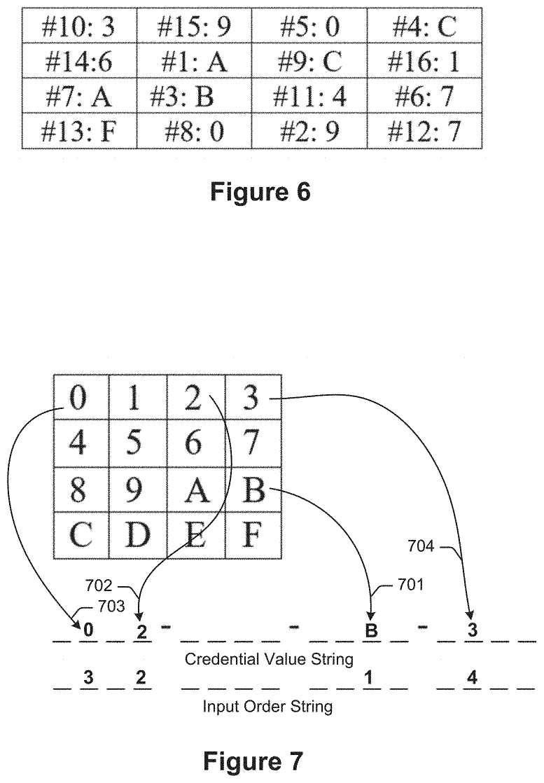

Alternately, the user can drag a hexadecimal symbol in a 4×4 grid in the sequence illustrated in FIG. 6. FIG. 6 illustrates a credential value string and an input order string which are generated as two parts of a credential key based on a user moving (e.g., dragging on a touch display) symbols arranged in a grid, in accordance with some embodiments of the present disclosure. The credential value string part of the credential key, is generated to indicate the sequence of hexadecimal symbols in the 4×4 grid (e.g., the arrangement of hexadecimal symbols in the 4×4 grid). The input order string part of the credential key is generated to indicate an order (illustrated in FIG. 6 by “#” input order numbers) in which individual ones of the sequence of hexadecimal symbols were separately dragged by the user to final locations in the 4×4 grid.

In some other embodiments, a user drags a credential value from a table to a credential string line which is displayed on a display device. FIG. 7 illustrates a credential value string and an input order string which are generated as two parts of a credential key based on a user dragging symbols from a grid to spaced apart locations on a display device to assemble a sequence which forms the credential value string in accordance with some embodiments of the present disclosure.

Referring to FIG. 7, as a first input the user drags 701 the credential symbol (value) “B” from the table to the 11th location in the credential value string. As a second input the user drags 702 the credential symbol (value) “2” from the table to the 4th location in the credential value string. As a third input the user drags 703 the credential symbol (value) “0” from the table to the 1st location in the credential value string. As a fourth input the user drags 704 the credential symbol (value) “3” from the table to the 14th location in the credential value string. Continuing in this manner, the user separately enters the rest of the credential values into the remaining locations in the credential value string. The electronic device also concurrently generates the corresponding input order string, which may or may not be displayed to the user. In the illustrated example of FIG. 7, the input order string has been shown which was generated based on the order of the four user inputs. Thus, the partially completed credential value string includes values “0.0.2 . . . B . . . 3 . . . ” and the partially completed input order string includes values “0.3.2 . . . 1 . . . 4.”

Corresponding operations that may be performed by an electronic device can include displaying a plurality of values at spaced apart locations on a display device. The operations assemble a sequence of values which is displayed on the display device responsive to user commands moving individual ones of the plurality of values to locations in the assembled sequence of values. The operations generate the credential value string to indicate the assembled sequence of values responsive to a user entry indicating completion of assembly of the credential value string, and generate the input order string to indicate an order in which individual ones of the plurality of values were moved by the user to the locations in the sequence of values.

When the display device includes a touch sensitive display, the electronic device may operate to assemble the sequence of values which is displayed on the display device responsive to sensing the user drag individual ones of the plurality of values to locations in the assembled sequence of values.

The operations of these embodiments may be used for any type of credential key, including without limitation, passwords, PINs, software activation keys, etc.

Many known validation systems require user to adopt complex passwords which includes using “at least one number, one upper case letter, and one special symbol”, which provides about 70 different possibilities for each symbol. For an 8-symbol sequence, the password strength is log₂(8*70)=49.0 bits. An even higher complexity of 54 bits can be obtained by dragging just 9 symbols, where each symbol represents 4 bits (0 through F). Dragging symbols on a touch display may be considered more user-friendly by users than attempting to remember and entering a complex password through, for example, a small cellular phone touch sensitive display.

Some other embodiments are directed to a credential value string being input as a sequence of 1-bit symbols of length n. A user may only enter the logic “1” values in the bit sequence, and not need to enter the logic “0” values, or vice versa. The number of permutations, i.e., the number of sequences now depend on the number of logic “1” values in the sequence. A sequence with s logic “1” values can be arranged in

$${}_{s}^{n} P = \frac{n !}{( n - s ) !} ways .$$

Thus, the total number of sequences is

$${\sum }_{s = 0}^{n} \frac{n !}{( n - s ) !} = [ e * n ! ] ,$$

where e is Euler's number, approximately 2.72. Thus, these sequences can encode log₂└e·n!┘ number of bits. The table below illustrates example sample values according to this encoding of a credential value string:

| n | log₂└e · n!┘ |
|---|---|
| 3 | 4 |
| 4 | 6 |
| 5 | 8 |
| 6 | 10 |
| 16 | 45 |
| 25 | 85 |
| 36 | 139 |
| 49 | 210 |

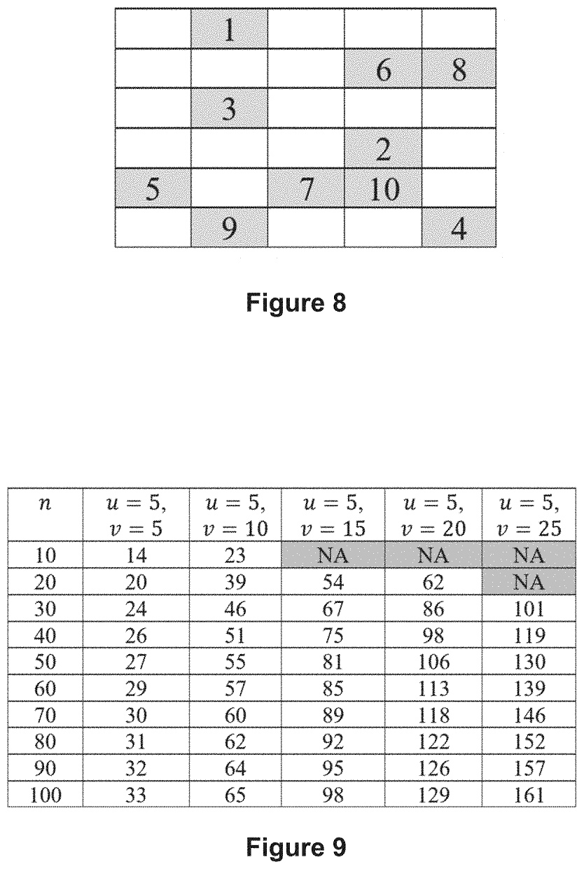

Continuing with the example with 108 bits, n=30 with log₂└e·n!┘=109. In other words, a user can encode a 108-bit message by clicking positions in a 6×5 grid in a defined order. FIG. 8 illustrates a grid of symbols which are displayed for touch selection by a user to generate a credential value string and an input order string as two parts of a credential key in accordance with some embodiments of the present disclosure. In the grid of FIG. 8, a user has selected 10 symbols in the 6×5 grid in the input order indicated by the 1-10 numbers within the selected symbol locations. The credential value string is generated to indicate locations of the sequence of selected symbols, as a part of a credential key. The input order string is generated to indicate an order in which individual ones of the sequence of selected symbols were separately selected by the user, as another part of the credential key.

Entering long sequences one click at a time, may be considered cumbersome by users. Short sequences are easier to compromise and may be unacceptably weak to malicious attack. To address these concerns, some embodiments increase n and limit s in the previous example. For example, to limit the number of ones between u and v, then the number of possibilities become

$${\sum }_{s = u}^{v} \frac{n !}{( n - s ) !} .$$

This can be computed using the following Python code:

log 2(sum([factorial(n)/factorial(n−s) for s in range(u,v+1)]))

FIG. 9 illustrates a table which shows the number of permutations provided by different lengths of credential value strings and number of ones in accordance with some embodiments of the present disclosure.

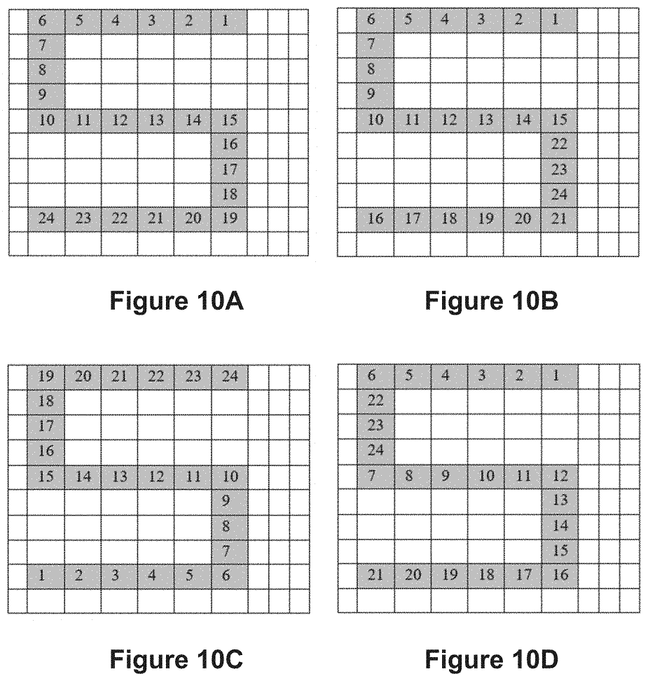

The higher values of n can be leveraged to allow users to “draw” patterns instead of selecting (e.g., clicking or touch-selecting) symbols one at a time. FIGS. 10A, 10B, 10C, and 10D illustrate four alternative patterns of blocks in a grid which have been selected by a user to generate a credential value string as one part of a credential key and further illustrate associated orders in which the user separately selected the blocks to generate the input order string as another part of credential key, in accordance with some embodiments of the present disclosure.

In the embodiment of FIG. 10A, the user has drawn a block-S pattern which forms the credential value string part of a credential key. The Figure also illustrates through the numbers within the blocks the order in which individual ones of the sequence of blocks were selected by the user, e.g., by dragging a finger on a touch-screen or mouse cursor, to define the input order string as another part of the credential key.

Each of FIGS. 10B, 10C, and 10D further illustrate that the user has drawn the same block-S pattern as shown in FIG. 10A to form the credential value string, but with different orders in which individual ones of the sequence of blocks were selected by the user to define the input order strings. Thus, although the user input in FIGS. 10A, 10B, 10C, and 10D all result in the same credential value string, each of these figures results in a different input order strings. The resulting credentials keys (combining the credential value string and the input order string) for each of FIGS. 10A, 10B, 10C, and 10D are therefore different.

Some users may prefer to drag a finger on a touch display or mouse cursor on a display to input a credential key but drawing line segments, instead of clicking on individual block or symbol locations on the display.

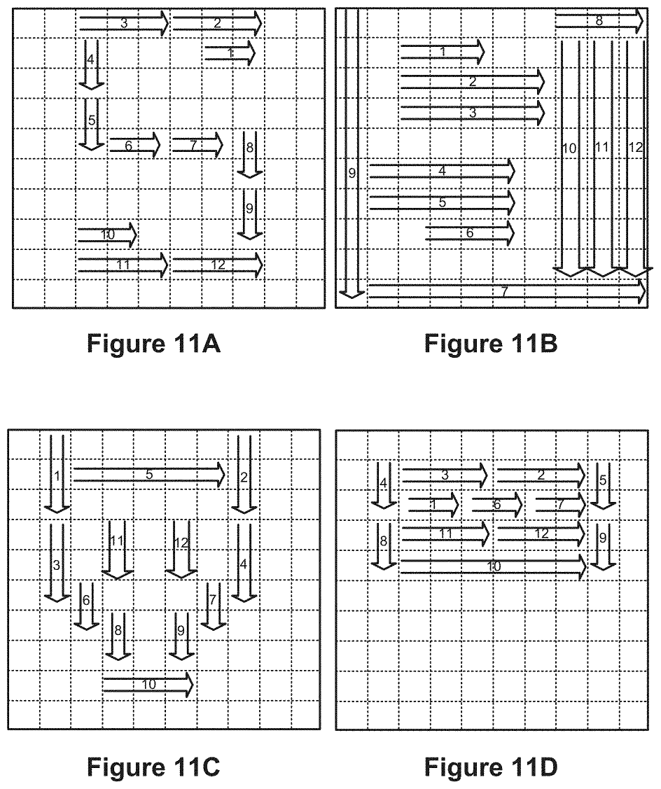

A credential value string may be generated from a plurality of line segments spanning multiple locations on a display. If the line segments have a minimum length of 2 locations (e.g., two blocks), they can be mirrored to double the number of possible entries. A mirrored segment is one in which the locations get clicked in reverse order (e.g. left to right vs. right to left). For symbols divided into n segments, the possible combinations are n+log₂ n!. The number of bits this can encode can become very large (e.g., 40 bits for n=12). Examples of symbols broken into 12 different segments are shown in FIGS. 11A, 11B, 11C, and 11D.

FIGS. 11A, 11B, 11C, and 11D illustrate four alternative patterns of blocks in a grid which have been selected by a user to form a stylized “S” as a credential value string for one part of a credential key and further illustrate by the numbers associated orders in which the user separately selected the blocks to generate the input order string as another part of credential key, in accordance with some embodiments of the present disclosure.

These symbols can be shifted left-to-right or top-to-bottom to encode additional bits. Mirroring asymmetric symbols can also lead to additional 1 bit encoding, to reduce the total number of unique patterns.

Corresponding operations that may be performed by an electronic device can include to display an n by m grid of indicia on a display device which are separately selectable by the user, wherein n and m are positive plural integers. The operations generate the credential value string to indicate which of the indicia of the grid have been selected by the user, and generate the input order string to indicate an order in which individual ones of the indicia of the grid were selected by the user.

The operations may generate the credential value string to further indicate which of the indicia of the grid have not been selected by the user.

The operations may generate of the credential value string by setting a defined binary value for locations in the credential value string corresponding to individual ones of the indicia of the grid that are selected by the user.

The operations may generate of the credential value string by setting each location in the credential value string to a defined binary value, and then toggling a binary value at a location in the credential value string from a current binary value to an opposite new binary value responsive to selection of one of the indicia of the grid by the user corresponding to the location in the credential value string.

The operations may change color, shading, and/or shape of individual ones of the grid of indicia displayed on the display device responsive to user selection of the individual ones of the indicia of the grid.

The operations may generate the input order string to indicate an order in which individual ones of the indicia of the grid were selected by the user dragging a finger across the individual ones of the indicia displayed on a touch sensitive display device or an order in which individual ones of the indicia of the grid were selected by the user dragging a cursor across the individual ones of the indicia while a mouse selection button was actuated.

Various embodiments of the present disclosure may thereby provide one or more of: 1) increased cryptographic strength of a credential key without increasing the required length of the user's inputted credential value string; 2) improved usability from a user's perception by enabling the user to sequentially drag symbols which have been display on a display device to locations on the display to define the sequential value string and input order string parts of a credential key for validation; 3) improved usability from a user's perception by enabling the user to click on locations on the screen to define the sequential value string and input order string parts of a credential key for validation; and 4) improved usability from a user's perception by enabling the user to define the sequential value string and input order string parts of a credential key by dragging a finger or mouse cursor through a sequence of strokes that draws a desired symbol.

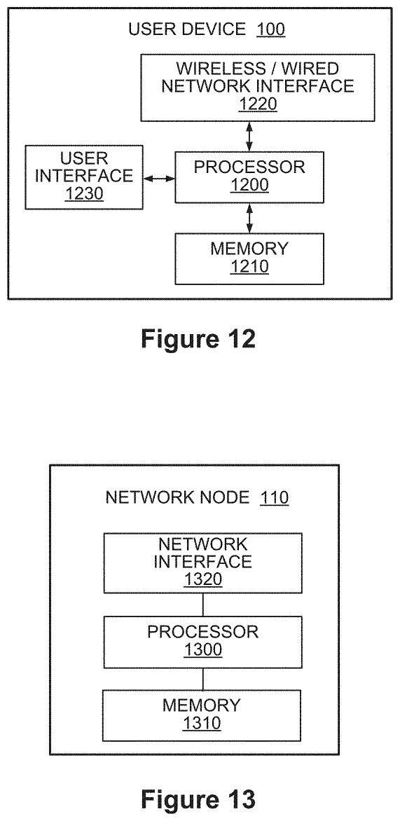

FIG. 12 illustrates components of a user device 100 which are configured to operate in accordance with some embodiments of the present disclosure. Referring to FIG. 12, the user device 100 can include a wired and/or wireless network interface circuit 1220, a user interface 1230 (e.g., touch sensitive display, physical keyboard, physical keypad, mouse, etc.), at least one processor circuit 1200 (processor), and at least one memory circuit 1210 (memory). The processor 1200 is connected to communicate with the other components. The memory 1210 stores program code that is executed by the processor 1200 to perform operations disclosed herein. The memory 1210 may also store the credential key repository 113 of FIG. 1. The processor 1200 may include one or more data processing circuits (e.g., microprocessor and/or digital signal processor), which may be collocated or distributed across one or more data networks. The processor 1200 is configured to execute the program code in the memory 1210, described below as a computer readable medium, to perform some or all of the operations and methods for one or more of the embodiments disclosed herein for a user device or other electronic device.

FIG. 13 illustrates components of a network node 110 which are configured to operate in accordance with some embodiments of the present disclosure. Referring to FIG. 13, the network node 110 can include a wired and/or wireless network interface circuit 1320, at least one processor circuit 1300 (processor), and at least one memory circuit 1310 (memory). The network node 110 may include a user interface adapted to receive a credential key from a user. The processor 1300 is connected to communicate with the other components. The memory 1310 stores program code that is executed by the processor 1300 to perform operations disclosed herein for a network node or other electronic device. The memory 1310 may also store the credential key repository 113 of FIG. 1. The processor 1300 may include one or more data processing circuits (e.g., microprocessor and/or digital signal processor), which may be collocated or distributed across one or more data networks.

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. A computer program product comprising:
a non-transitory computer readable medium storing instructions executable by at least processor of an electronic device to:
obtain a credential value string indicating a sequence of credential values entered by a user through a user interface as part of a credential key,
obtain an input order string indicating an order in which individual ones of the sequence of credential values were separately entered by the user through the user interface as another part of the credential key, and
validate the credential key based on the credential value string and based on the input order string.

2. The computer program product of claim 1, wherein the instructions executable by the at least processor are further operative to validate the credential key based on:
comparing the sequence of credential values indicated by the credential value string to credential values of a predefined credential value string and based on comparing the order indicated by the input order string to a predefined input order of a predefined credential order string.

3. The computer program product of claim 2, wherein the instructions executable by the at least processor are further operative to:
access a repository of credential keys using an identifier of the user to obtain the predefined credential value string and the predefined credential order string for the user.

4. The computer program product of claim 1, wherein the instructions executable by the at least processor are further operative to validate the credential key based on:
comparing a credential key value generated based on an algorithmic combination of the credential value string and the input order string to a predefined credential key value.

5. The computer program product of claim 1, wherein the instructions executable by the at least processor are further operative to:
selectively grant the user access to resources of the electronic device based on an outcome of the validation of the credential key.

6. The computer program product of claim 1, wherein the instructions executable by the at least processor are further operative to:
access a repository of credential keys using an identifier of a software and/or hardware resource to obtain the predefined credential value string and the predefined credential order string for the identified software and/or hardware resource.

7. The computer program product of claim 1, wherein the instructions executable by the at least processor are further operative to:
display a plurality of indicia on a display device, each of the indicia indicating a location where the user can enter one of the credential values;
generate the credential value string to indicate credential values entered by the user at the locations indicated by the plurality of indicia; and
generate the input order string to indicate an order in which individual ones of the credential values were entered at the locations indicated by the plurality of indicia were selected by the user.

8. The computer program product of claim 1, wherein the instructions executable by the at least processor are further operative to:
display a plurality of values at spaced apart locations on a display device;
assemble a sequence of values which is displayed on the display device responsive to user commands moving individual ones of the plurality of values to locations in the assembled sequence of values;
generate the credential value string to indicate the assembled sequence of values responsive to a user entry indicating completion of assembly of the credential value string; and
generate the input order string to indicate an order in which individual ones of the plurality of values were moved by the user to the locations in the sequence of values.

9. The computer program product of claim 8, wherein display device comprises a touch sensitive display, and the instructions executable by the at least processor are further operative to:
assemble the sequence of values which is displayed on the display device responsive to sensing the user drag individual ones of the plurality of values to locations in the assembled sequence of values.

10. The computer program product of claim 1, wherein the instructions executable by the at least processor are further operative to:
display an n by m grid of indicia on a display device which are separately selectable by the user, wherein n and m are positive plural integers;
generate the credential value string to indicate which of the indicia of the grid have been selected by the user; and
generate the input order string to indicate an order in which individual ones of the indicia of the grid were selected by the user.

11. The computer program product of claim 10, wherein the instructions executable by the at least processor are further operative to generate the credential value string to further indicate which of the indicia of the grid have not been selected by the user.

12. The computer program product of claim 10, wherein the instructions executable by the at least processor are further operative to generate of the credential value string by setting a defined binary value for locations in the credential value string corresponding to individual ones of the indicia of the grid that are selected by the user.

13. The computer program product of claim 10, wherein the instructions executable by the at least processor are further operative to generate of the credential value string by:
setting each location in the credential value string to a defined binary value;
toggle a binary value at a location in the credential value string from a current binary value to an opposite new binary value responsive to selection of one of the indicia of the grid by the user corresponding to the location in the credential value string.

14. The computer program product of claim 10, wherein the instructions executable by the at least processor are further operative to:
change color, shading, and/or shape of individual ones of the grid of indicia displayed on the display device responsive to user selection of the individual ones of the indicia of the grid.

15. The computer program product of claim 10, wherein the instructions executable by the at least processor are further operative to:
generate the input order string to indicate an order in which individual ones of the indicia of the grid were selected by the user dragging a finger across the individual ones of the indicia displayed on a touch sensitive display device or an order in which individual ones of the indicia of the grid were selected by the user dragging a cursor across the individual ones of the indicia while a mouse selection button was actuated.

16. A computer program product comprising:
a non-transitory computer readable medium storing instructions executable by at least processor of an electronic device to:
obtain a credential value string indicating a sequence of credential values entered by a user through a user interface as part of a credential key,
obtain an input order string indicating an order in which individual ones of the sequence of credential values were separately entered by the user through the user interface as another part of the credential key, and
validate the credential key based on the credential value string and based on the input order string,
wherein the credential value string is formed as a sequence of three credential values.

17. A computer program product comprising:
a non-transitory computer readable medium storing instructions executable by at least processor of an electronic device to:
obtain a credential value string indicating a sequence of credential values entered by a user through a user interface as part of a credential key,
obtain an input order string indicating an order in which individual ones of the sequence of credential values were separately entered by the user through the user interface as another part of the credential key, and
validate the credential key based on the credential value string and based on the input order string,
wherein the electronic device includes a network node, the network node configured to obtain a credential value string which indicates a sequence of credential values entered by a user through a user interface as part of a credential key.

18. The computer program product of claim 17, wherein the network node obtains the input order string which indicates an order in which individual ones of the sequence of credential values were separately entered by the user through the user interface as another part of the credential key.

19. The computer program product of claim 17, wherein the instructions executable by the at least processor are further operative to generate of the credential value string by:
setting each location in the credential value string to a defined binary value;
toggle a binary value at a location in the credential value string from a current binary value to an opposite new binary value responsive to selection of one of the indicia of the grid by the user corresponding to the location in the credential value string.

20. The computer program product of claim 17, wherein the instructions executable by the at least processor are further operative to:
display an n by m grid of indicia on a display device which are separately selectable by the user, wherein n and m are positive plural integers;
generate the credential value string to indicate which of the indicia of the grid have been selected by the user; and
generate the input order string to indicate an order in which individual ones of the indicia of the grid were selected by the user.
